(19) United States
(12) Patent Application Publication
(10) Pub. No.: US 2022/0206597 A1
(43) Pub. Date: Jun. 30, 2022

(54) DIGITAL PEN FOR BRUSH SIMULATION INPUT

(71) Applicant: Sony Interactive Entertainment LLC, San Mateo, CA (US)

(72) Inventor: Rebecca Abel, San Mateo, CA (US)

(21) Appl. No.: 17/161,554

(22) Filed: Jan. 28, 2021

Related U.S. Application Data
(60) Provisional application No. 63/131,733, filed on Dec. 29, 2020.

(51) Int. Cl. G06F 3/0354; G02B 6/06; G06F 3/038; G06T 11/20; G06F 3/03

(52) U.S. Cl. CPC G06F 3/03545; G02B 6/06; G06F 3/0308; G06F 3/03542; G06T 11/203; G06F 3/038

(57) ABSTRACT

A digital pen for drawing via a display panel has a body and a tip. The body includes processing circuitry for processing input data and communicating input control to a processor associated with the display panel. The tip, which has a connector for coupling to the body and a contact interface, includes capture circuitry that processes sensor data from the contact interface and produces input data interfaced to the processing circuitry. The contact interface is defined by the flexible fibers, each of which has a fiber end configured to contact the display panel for producing sensor data. The sensor data identifies an amount of flex contact of the flexible fibers, and the amount of flex contact is correlated to an intensity of line draw for the fiber ends of the fibers. The input control includes instructions usable by the processor to produce a simulated brush stroke on the display panel.

### CLAIM OF PRIORITY

This application claims priority to and the benefit of U.S. Provisional Application No. 63/131,733 filed on Dec. 29, 2020, entitled “Digital Pen For Brush Simulation Input,” the disclosure of which is incorporated herein by reference in its entirety for all purposes.

### BACKGROUND

Digital painting is an art form in which traditional painting techniques are applied using digital tools by means of a computer, a graphics tablet and an input device, e.g., a digital pen or stylus, and content creation software. In digital painting, the artist moves the digital pen on a digital canvas, e.g., the surface of a graphics tablet, and this movement of the digital pen is captured as a single input for use by the content creation software. The content creation software generates the virtual brush stroke using the single input from the digital pen. As such, the virtual brush stroke is generated, for the most part, by the content creation software and does not truly reflect the ability of the artist.

It is in this context that embodiments arise.

### SUMMARY

In an example embodiment, a digital pen for use in drawing via a display panel is provided. The body of the digital pen, which has a first end and a second end, includes processing circuitry for processing input data and communicating input control to a processor associated with the display panel. The tip of the digital pen has a connector for coupling to the first end of the body of the pen and a contact interface opposite the connector. The tip of the pen also includes capture circuitry that processes sensor data from the contact interface and produces the input data that is interfaced to the processing circuitry of the body. The contact interface is defined by a plurality of flexible fibers, with each of the plurality of flexible fibers having a fiber end that is configured to contact a surface of the display panel for producing the sensor data. The sensor data identifies an amount of flex contact of each of the plurality of flexible fibers, and the amount of flex contact is correlated to an intensity of line draw for each of the fiber ends of the plurality of flexible fibers. The input control includes instructions usable by the processor to produce a simulated brush stroke on the display panel.

In one embodiment, each of the plurality of flexible fibers is defined by a fiber optic strand and an end opposite the fiber end of each fiber optic strand connects to an optical sensor array. In one embodiment, the optical sensor array is configured to individually emit light to each fiber optic strand and receive reflected light from each of the respective fiber ends. The received reflected light represents the sensor data from the contact interface.

In one embodiment, the tip of the digital pen further includes a microcontroller that receives the sensor data and produces the input data that is communicated to the connector via a pen tip interface. In one embodiment, the simulated brush stroke is in part generated by digitally producing a plurality of interpolated line draws with respective line weights based on the intensity line draw determined for each of the plurality of flexible fibers. In one embodiment, the simulated brush stroke produces a graphical brush stroke on an interface rendered on the display panel.

In one embodiment, the simulated brush stroke produces a graphical brush stroke on an interface rendered on the display panel, and the capture circuitry and the processing circuitry of the digital pen are configured to produce the input control for a period of time when at least one of the fiber ends produces sensor data indicative of a continuing of the simulated brush stoke along a drawing trajectory across a portion of the display panel.

In one embodiment, the simulated brush stroke is in part generated by digitally producing a plurality of interpolated line draws with respective line weights based on the intensity of the line draw determined for each of the plurality of flexible fibers, and the intensity of the line draw changes, responsive to an amount of the contact of the plurality of flexible fibers with the surface of the display panel, wherein the changes in the intensity of the line draw affect an intensity of the simulated brush stroke while moving the plurality of flexible fibers along the drawing trajectory.

In one embodiment, each of the plurality of flexible fibers includes a shielding cover that extends toward the fiber ends, the fiber ends being free of the shielding cover to enable the fiber ends to contact the surface of the display panel. In one embodiment, the digital pen further includes a magnetic cover that surrounds the shielding cover. The magnetic cover is configured to assist in keeping the plurality of flexible fibers substantially together.

In one embodiment, the processing circuitry includes a communication chip, a microcontroller, a pen body interface, and a power source. In one embodiment, the capture circuitry includes an optical sensor array, a microcontroller with cache, and a pen tip interface. In one embodiment, the plurality of flexible fibers includes at least three flexible fibers and at least three corresponding fiber ends.

In another example embodiment, a method for generating input control from a digital pen, which has a pen body and a tip and is used for drawing on a display panel, is provided. The method includes capturing sensor data from one or more of a plurality of flexible fibers that extend out of the tip, and detecting an intensity of line draw associated with one or more of the plurality of flexible fibers. The intensity of the line draw is correlated to an amount of contact each of the one or more of the plurality of flexible fibers receives when placed upon a surface of the display panel. The method also includes sending input control to a processor, with the input control including data usable by the processor to generate a simulated brush stroke. The simulated brush stroke is configured to be rendered on the display panel responsive to the amount of contact each of the one or more of the plurality of flexible fibers receives when placed upon the surface of the display panel.

In one embodiment, generating the simulated brush stroke by the processor includes processing an interpolation process, with the interpolation process being configured to digitally produce a plurality of interpolated line draws with respective line weights based on the intensity of the line draw associated with each of one of more of the plurality of flexible fibers.

In one embodiment, each of the plurality of flexible fibers is defined by a fiber optic strand, and capturing sensor data from the plurality of flexible fibers that extend out of the tip includes individually emitting light to each fiber optic strand, and receiving reflected light from ends of one or more of the fiber optic strands, with the ends of the one or more of the fiber optic strands contacting a surface of the display panel.

In one embodiment, the capturing of sensor data from the plurality of flexible fibers that extend out of the tip includes capturing sensor data from at least three flexible fibers. In one embodiment, the plurality of flexible fibers that extend out of the tip is arranged in a pattern that simulates a round brush. In one embodiment, the plurality of flexible fibers that extend out of the tip is arranged in a pattern that simulates a flat brush. In one embodiment, the plurality of flexible fibers that extend out of the tip is arranged in a pattern that simulates a fan brush.

Other aspects and advantages of the disclosures herein will become apparent from the following detailed description, taken in conjunction with the accompanying drawings, which illustrate by way of example the principles of the disclosures.

### BRIEF DESCRIPTION OF THE DRAWINGS

FIG. 1 illustrates a simplified overview of a system for digital painting including a digital pen having multiple inputs, in accordance with one embodiment..

FIG. 2 is a simplified schematic diagram that illustrates additional details of a digital pen having multiple inputs, in accordance with one embodiment.

FIG. 3 is a simplified diagram that illustrates additional details of the pen tip, in accordance with one embodiment.

FIG. 4A is a sectional view illustrating additional details regarding the configuration of the pen tip and the connection of the pen tip to the pen body, in accordance with one embodiment.

FIG. 4B is a cross-sectional view of the pen tip taken along section A-A shown in FIG. 4A, in accordance with one embodiment.

FIGS. 5A and 5B are front and side views, respectively, of the pen tip that shows the location of the holes formed in the pen tip for the flexible fibers, in accordance with one embodiment.

FIG. 6 is a front view of the pen tip that shows the location of the holes formed in the pen tip for the flexible fibers, in accordance with another embodiment.

FIG. 7 is a front view of the pen tip that shows the location of the holes formed in the pen tip for the flexible fibers, in accordance with yet another embodiment.

FIG. 8 is a front view of the pen tip that shows the location of the holes formed in the pen tip for the flexible fibers, in accordance with a further embodiment.

FIG. 9 shows a sleeve surrounding a fiber optic strand such that an end portion of the fiber optic strand extends beyond the end of the sleeve, in accordance with one embodiment.

FIG. 10A illustrates a digital pen having multiple inputs being moved on the surface of a display panel, in accordance with one embodiment.

FIG. 10B illustrates the line draw for each the flexible fibers shown in FIG. 10A, in accordance with one embodiment.

FIG. 10C illustrates a graphical brush stroke on an interface rendered on a display panel, in accordance with one embodiment.

FIGS. 11A-11C illustrate additional details of the interpolation process used to convert the line draws into a simulated brush stroke, in accordance with one embodiment.

FIG. 12 is a flow diagram illustrating the method operations performed in generating input control from a digital pen used for drawing on a display panel, in accordance with an example embodiment.

FIG. 13 illustrates an embodiment of an Information Service Provider architecture.

### DETAILED DESCRIPTION

In the following description, numerous specific details are set forth in order to provide a thorough understanding of the example embodiments. However, it will be apparent to one skilled in the art that the example embodiments may be practiced without some of these specific details. In other instances, process operations and implementation details have not been described in detail, if already well known.

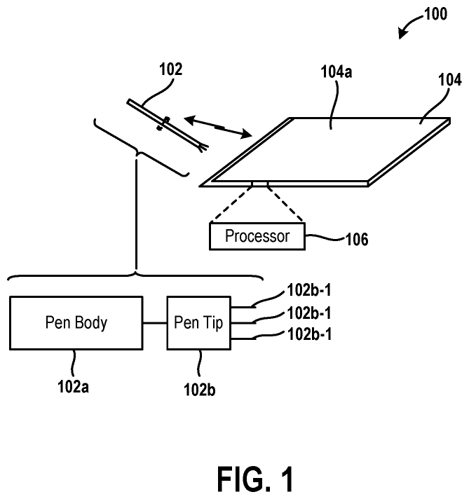

FIG. 1 illustrates a simplified overview of a system for digital painting including a digital pen having multiple inputs, in accordance with one embodiment. As shown in FIG. 1, system 100 includes a digital pen 102, a display panel 104, and a processor 106 associated with the display panel. The processor 106 can be located on the display panel 104, e.g., the display panel is part of a tablet computer, or can be located on a computer, e.g., a desktop or laptop computer, connected to the display panel. The digital pen 102 includes a pen body 102a and a pen tip 102b, which has multiple inputs 102b-1. As shown in FIG. 1, pen tip 102b has three inputs; however, the number of inputs can be greater than three as will be described in more detail below.

In use, a user, e.g., a digital artist, moves the digital pen 102 on the surface 104a of the display panel 104 so that the inputs 102b-1 contact the surface of the display panel. As the digital pen 102 moves on the surface 104a of the display panel 104, the inputs 102b-1 produce sensor data that reflects the relative amount of contact that the inputs have with the surface of the display panel. The digital pen 102 also can include an inertial sensor that produces sensor data that reflects the angle of the digital pen and the motion, e.g., acceleration, of the digital pen. In one embodiment, the relative amount of contact that each of the inputs 102b-1 has with the surface 104a of the display panel 104 is correlated to the intensity of line draw for each of the inputs. The sensor data is interfaced to processing circuitry of the pen body 102a and the processing circuitry communicates input control to the processor 106 associated with the display panel 104. The processor 106 executes content creation software to generate a simulated brush stroke and the simulated brush stroke produces a graphical brush stroke on an interface rendered on the display panel 104.

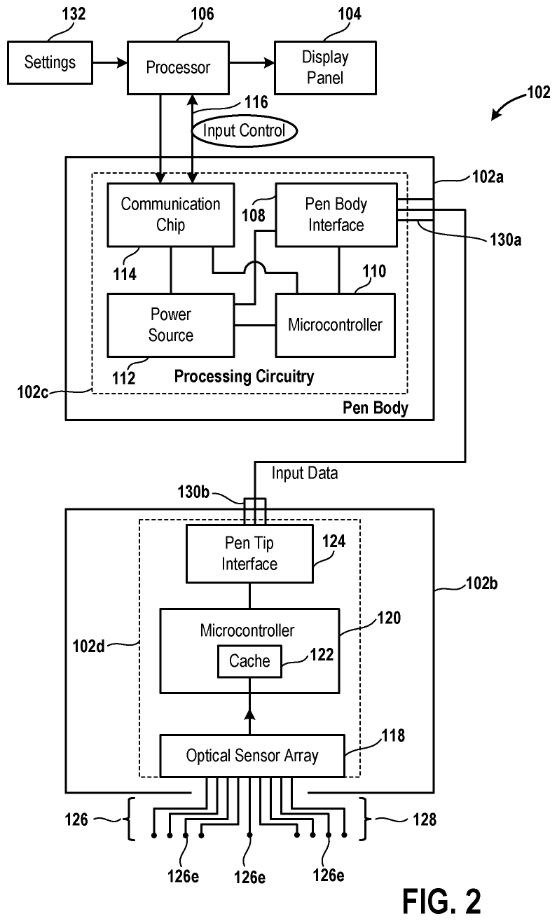

FIG. 2 is a simplified schematic diagram that illustrates additional details of a digital pen having multiple inputs, in accordance with one embodiment. As shown in FIG. 2, digital pen 102 includes pen body 102a and pen tip 102b. The pen body 102a includes processing circuitry 102c, which includes pen body interface 108, microcontroller 110, power source 112, and communication chip 114. Power source 112, e.g., a rechargeable battery, is coupled to each of pen body interface 108, microcontroller 110, and communication chip 114 to provide power thereto. Power source 112 also provides power for the electronic components in the pen tip 102b. The processing circuitry 102c processes input data and communicates input control 116 to processor 106 associated with display panel 104, as will be explained in more detail below.

Pen tip 102b includes capture circuitry 102d, which includes sensor array 118, microcontroller 120 provided with cache 122, and pen tip interface 124. A plurality of flexible fibers 126 extends from sensor array 118. One end of each flexible fiber 126 is connected to sensor array 118 and the other end of each flexible fiber forms part of contact interface 128 of the pen tip 102b. In particular, the contact interface 128 is defined by the plurality of flexible fibers 126, with each of the flexible fibers having a fiber end 126e that is configured to contact the surface of a display panel, e.g., display panel 104, for producing sensor data. In one embodiment, each of the plurality of flexible fibers 126 is defined by a fiber optic strand. In this embodiment, the sensor array 118 is an optical sensor array and the end opposite of the fiber end 126e of each fiber optic strand 126 connects to the optical sensor array. The capture circuitry 102d processes sensor data from the contact interface 128 and produces the input data that is interfaced to the processing circuitry 102c of the pen body 102a, as will be explained in more detail below.

The pen body 102a and the pen tip 102b can be joined together by any suitable connection technique. As shown in FIG. 2, pen body 102a includes connector 130a and pen tip 102b includes connector 130b. The connectors 130a and 130b can be any suitable connectors, e.g., snap-fit connectors or threaded connectors. In one embodiment, connector 130b is a threaded connector including a threaded insertion portion and connector 130a is a threaded connector including a complementarily threaded receiving portion. The connectors 130a and 130b also include corresponding pins and receptacles. As such, in this example embodiment, when the connectors 130a and 130b are threaded together to create a secure mechanical connection between the pen body 102a and the pen tip 102b, the corresponding pins and receptacles in the connectors are brought into electrical contact with one another to allow sensor data to be transmitted from the pen tip to the pen body. The pins and receptacles in the connectors 130a and 130b also can be used to transmit power from the power source 112 in the pen body 102a to the electronic components in the pen tip 102b including pen tip interface 124, microcontroller 120 provided with cache 122, and sensor array 118. Alternatively, power can be transmitted from the pen body 102a to the pen tip 102b along the outside of the threaded insertion portion of connector 130b.

In the example embodiment in which sensor array 118 is an optical sensor array, the optical sensor array includes a light emitter, e.g., a light emitting diode (LED), and a sensor for each of the fiber optic strands 126. The light from a light emitter travels along a fiber optic strand 126 until it reaches the fiber end 126e of the fiber optic strand. In the event the fiber end 126e is in contact with a reflective surface, e.g., the surface of a display panel, the light reflected from the reflective surface will travel back along the fiber optic strand 126 and get detected as reflected light by the sensor associated with the fiber optic strand. Those skilled in the art will appreciate that the amount of reflected light detected by the sensor can include a certain amount of noise resulting from, e.g., light reflecting from other fiber optic strands, increased reflection caused by an extremely reflective surface, etc. As such, the sensor data used by the content creation software should be normalized to account for such noise.

To enable the reflected light to be detected by the sensor without interference from light being emitted by the light emitter, the light emitter does not emit light continuously, but rather emits light in pulses. In other words, the light emitter alternates between being on for a certain period of time, during which light is emitted, and being off for a certain period of time, during which no light is emitted. The sensor detects the reflected light during the period of time in which the light emitter is off. In one embodiment, the period of time is about a tenth of a second. Those skilled in the art will appreciate that the rate at which the light is pulsed may be varied to meet the needs of particular applications.

In this example embodiment, the microcontroller 120 controls the optical sensor array 118. In particular, the microcontroller 120 controls the pulsing of the light emitters associated with each of the fiber optic strands 126, e.g., the microcontroller controls when the light emitters are on and when the light emitters are off. The microcontroller 120 also controls when the sensors associated with each of the fiber optic strands 126 capture the reflected light and send this sensor data to cache 122. In this manner, the microcontroller 120 ensures that the sensor data is stored in an ordered fashion in the cache 122. In particular, at each point in time at which sensor data is captured, e.g., t₀, t₁, t₂, t₃, . . . tₙ, the sensor data for each of the sensors, e.g., S₁, S₂, S₃, . . . Sₙ, at that point in time is stored in the cache 122. Thus, in an example embodiment in which the optical sensor array 118 includes 12 sensors, the sensor data for each of the 12 sensors captured at a particular time, e.g., t₀, would be stored in the cache 122 in association with time t₀. The next time sensor data is captured, e.g., time t₁, the sensor data captured for each of the 12 sensors at time t₁ would be stored in cache 122 in association with time t₁. By storing the sensor data in the cache 122 in this manner, the cache enables the sensor data for each of the sensors to be ascertained over a period of time, e.g., the period of time during which a digital pen is moved on the surface of a display panel.

The pen tip interface 124 provides a path for the microcontroller 120 to send the sensor data in the cache 122 to the pen body 102a. By way of example, the pen tip interface 124 can be any suitable port, e.g., a serial port or a parallel port. The microcontroller 120 arranges the sensor data for transmission based on the type of port, as is well known by those skilled in the art, and the pen tip interface 124 transmits the sensor data to the pen body 102a as input data. The pen body interface 108 of the pen body 102a receives the input data and, if needed, the microcontroller 110 of the pen body rearranges the input data. The microcontroller 110 sends the input data to communication chip 114, which will reformat the input data in accordance with the communication protocol the communication chip is using. In one embodiment, the communication chip 114 uses the Bluetooth Low Energy (BLE) protocol. Those skilled in the art will appreciate that the communication chip 114 can also use other suitable wireless protocols.

Using the BLE protocol or other wireless protocol, the communication chip 114 transmits input control 116 to a paired device with which processor 106 is associated. In one embodiment, the paired device is a tablet computer and the processor 106 is located on the display panel 104 of the tablet computer. In another embodiment, the paired device is a computer and the processor 106 is located on the computer, which is connected to the display panel 104. The input control 116 includes the data generated on the digital pen 102, e.g., the sensor data from the optical sensor array 118 which is stored in the cache 122 as ordered data and then sent to the pen body 102a as input data. The content creation software, e.g., an application program, that resides on the processor 106 uses the input control 116 to create simulated brush strokes, as will be described in more detail below. The simulated brush strokes produce graphical brush strokes on an interface rendered on the display panel 104.

Settings 132 can be provided to processor 106 based on input received from the user via the application program. By way of example, the user can input settings 132 via a menu, a graphical slider, or other suitable interface of the application program. The settings 132 can include preferences for aspects of the digital painting process. In one embodiment, the settings 132 include preferences regarding the sensitivity of the digital pen to the user's input. For example, by adjusting the settings, the user could make the digital pen either more or less sensitive to pressure applied by the user. In one embodiment, the settings 132 include preferences regarding the graphical output generated using the ordered data from the digital pen. For example, by adjusting the settings, the user could adjust characteristics of the graphical brush strokes produced on the interface rendered on the display panel including, e.g., line density, color intensity, etc.

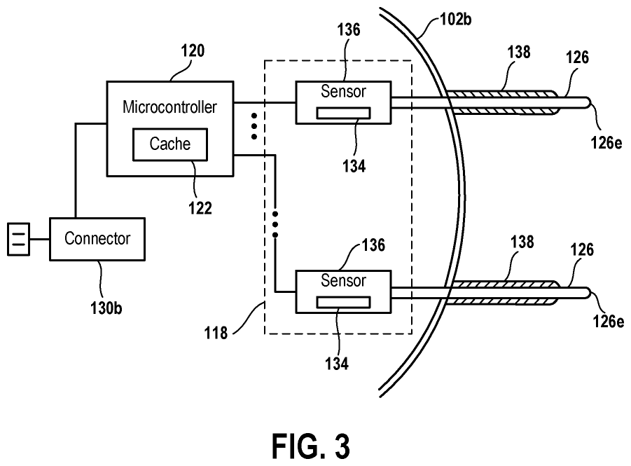

FIG. 3 is a simplified diagram that illustrates additional details of the pen tip, in accordance with one embodiment. As shown in FIG. 3, optical sensor array 118 includes a sensor 136 and a light emitter 134 for each fiber optic strand 126. In one embodiment, the light emitter 134 is a light emitting diode (LED). As described above with reference to FIG. 2, the light emitter 134, responsive to control signals from microcontroller 120, emits pulses of light which travel through fiber optic strand 126 to fiber end 126e. In the event fiber end 126e is in contact with a reflective surface, e.g., the surface of a display panel, the light reflected from the reflective surface will travel back along the fiber optic strand 126 and get detected as reflected light by the sensor 136 associated with the fiber optic strand. The sensor data from sensors 136 is stored in cache 122 in association with the time at which the sensor data was captured, as described above with reference to FIG. 2.

As shown in FIG. 3, each fiber optic strand 126 is surrounded by a sleeve 138. The sleeve 138 is configured such that the end portion of each fiber optic strand 126 protrudes from the sleeve. This configuration ensures that the fiber end 126e of each fiber optic strand 126 can directly contact the surface of a display panel or other reflective surface. In one embodiment, the sleeve 138 includes both an inner portion and an outer portion. In one embodiment, the inner portion of sleeve 138 is a shielding cover comprised of a metallic material, e.g., a thin aluminum foil, and the outer portion of the sleeve is a magnetic cover (or jacket) comprised of an insulating plastic material, e.g., polyvinyl chloride (PVC), having a magnetic material dispersed therein. In one embodiment, the insulating plastic material is a composite material that includes an amount of a ferromagnetic material, e.g., iron, nickel, etc., dispersed therein. The amount of the ferromagnetic material dispersed within the insulating plastic material is sufficient to render the composite material magnetic. As such, depending on the polarity, the sleeves made of the composite material will magnetically attract to one another and clump together when pressure is applied to the fiber optic strands during use of the digital pen. In this manner, the magnetic cover that forms part of sleeve 138 assists in keeping the plurality of flexible fibers substantially together during use of the digital pen.

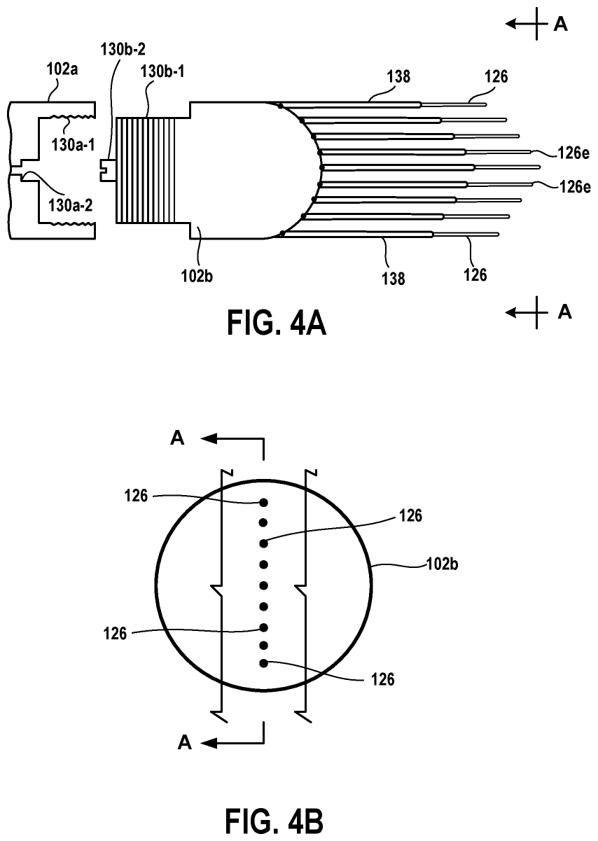

FIG. 4A is a sectional view illustrating additional details regarding the configuration of the pen tip and the connection of the pen tip to the pen body, in accordance with one embodiment. As shown in FIG. 4A, a plurality of fiber optic strands 126 protrude from the pen tip 102b. Each of the fiber optic strands 126 is surrounded by a sleeve 138 such that the end portion of each fiber optic strand, including fiber end 126e, protrudes from the sleeve. Connector 130b of pen tip 102b includes threaded portion 130b-1 and pin 130b-2. Connector 130a of pen body 102a includes threaded portion 130a-1, which includes complementary threads for receiving threaded portion 130b-1, and receptacle 130a-2. To connect pen tip 102b and pen body 102a, threaded portions 130b-1 and 130a-1 are threaded together to create a secure mechanical connection between the pen tip and the pen body. In the course of threading the threaded portions 130b-1 and 130a-1 together, the pin 130b-2 and the receptacle 130a-2 are brought into electrical contact with one another. As described above with reference to FIG. 2, the connection between the pin 130b-2 and the receptacle 130a-2 allows sensor data and power to be transmitted from the pen tip 102b to the pen body 102a. Those skilled in the art will appreciate that more than one pin can be provided on the pen tip, and that the number of receptacles provided on the pen body will correspond to the number of pins provided on the pen tip.

FIG. 4B is a cross-sectional view of the pen tip taken along section A-A shown in FIG. 4A, in accordance with one embodiment. As shown in FIG. 4B, the plurality of fiber optic strands 126 in the illustrated central slice of the pen tip 102b are arranged in a line. In one embodiment, as can be seen in FIG. 4A, the fiber ends 126e of these fiber optic strands 126 define a curved surface wherein, relative to a fixed reference plane on the pen tip 102b, the fiber ends of the fiber optic strands at the center of the pen tip extend further in a longitudinal direction than do the fiber ends of the fiber optic strands at the periphery of the pen tip. With this configuration, if the pen tip 102b were to be oriented perpendicularly to the surface of a display panel, the fiber ends of the fiber strands at the center of the pen tip would be in contact the surface of the display panel, whereas the fiber ends of the fiber optic strands at the periphery of the pen tip would not be in contact with the surface of the display panel. In another embodiment, the fibers ends 126e of these fiber optic strands 126 define a straight line wherein, relative to a fixed reference plane on the pen tip 102b, the fiber ends of the fiber optic strands at the center of the pen tip extend the same distance in a longitudinal direction as do the fiber ends of the fiber optic strands at the periphery of the pen tip. With this configuration, if the pen tip 102b were to be oriented perpendicularly to the surface of a display panel, the fiber ends of each the fiber strands would be in contact the surface of the display panel.

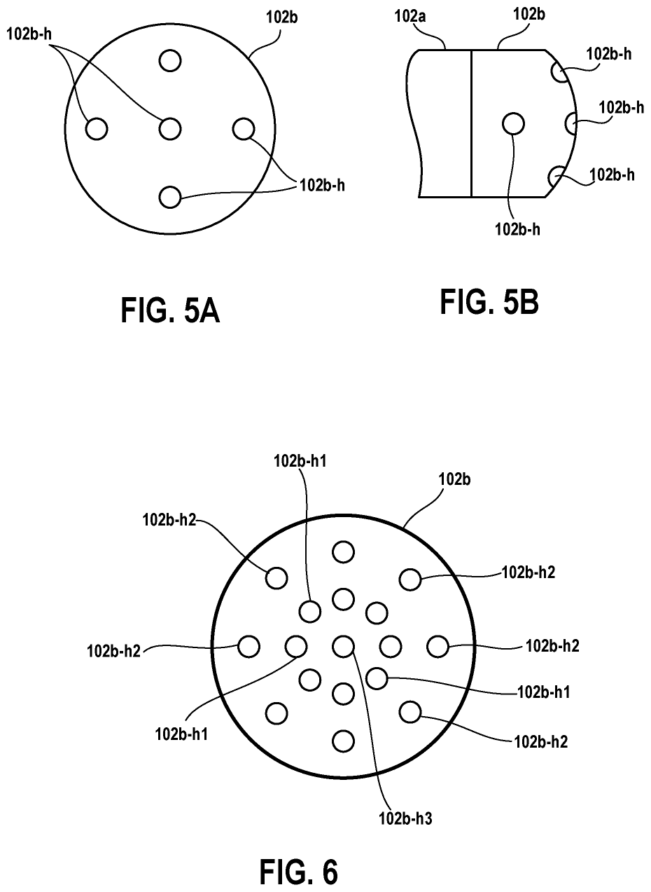

FIGS. 5A and 5B are front and side views, respectively, of the pen tip that shows the location of the holes formed in the pen tip for the flexible fibers, in accordance with one embodiment. As shown in FIG. 5A, the pen tip 102b has 5 holes 102b-h formed therein. As can be seen in both FIGS. 5A and 5B, one of the holes 102b-h is centrally located on the pen tip 102b and the other holes are peripherally located around the pen tip. When the pen tip is configured for a relatively low number of flexible fibers, e.g., 3 to 5 flexible fibers, the flexible fibers can be relatively thick. In one embodiment, the flexible fibers have a diameter of approximately 1 millimeter. Each of the holes 102b-h should have a size sufficiently large to accommodate the combined size, e.g., diameter, of the flexible fiber and any sleeve surrounding the flexible fiber.

FIG. 6 is a front view of the pen tip that shows the location of the holes formed in the pen tip for the flexible fibers, in accordance with another embodiment. As shown in FIG. 6, the pen tip 102b has 17 holes 102b-h formed therein. As can be seen in FIG. 6, one of the holes 102b-h3 is centrally located on the pen tip 102b and the other holes are located around the pen tip. In particular, a first group of 8 holes 102b-h1 is disposed around central hole 102b-h3 at a first radial distance from the central hole. A second group of 8 holes is peripherally disposed around the pen tip 102b at a second radial distance from the central hole 102b-h3, with the second radial distance being longer than the first radial distance. When the pen tip is configured for a mid-range number of flexible fibers, e.g., 15 to 30 flexible fibers, the flexible fibers should be relatively thin. In one embodiment, the flexible fibers have a diameter of approximately 0.1 millimeter. Each of the holes 102b-h1, 102b-h2, and 102b-h3 should have a size sufficiently large to accommodate the combined size, e.g., diameter, of the flexible fiber and any sleeve surrounding the flexible fiber.

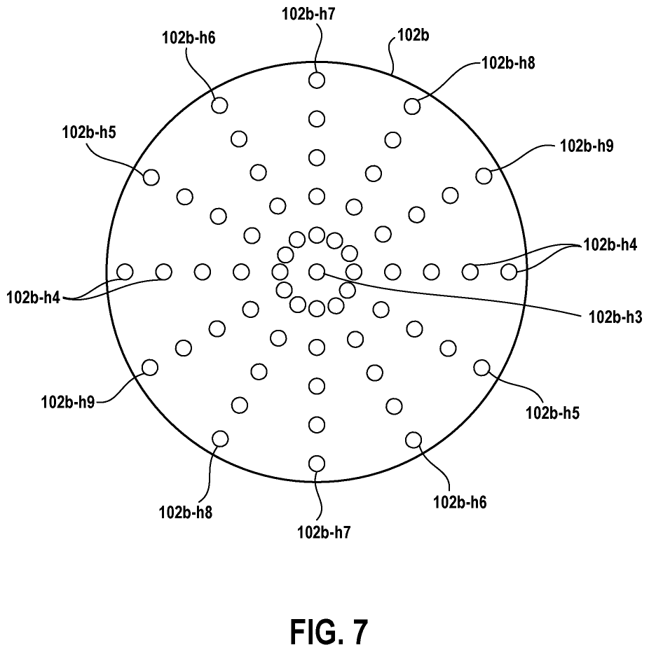

FIG. 7 is a front view of the pen tip that shows the location of the holes formed in the pen tip for the flexible fibers, in accordance with yet another embodiment. As shown in FIG. 7, the pen tip 102b has 61 holes formed therein. As can be seen in FIG. 7, one of the holes 102b-h3 is centrally located on the pen tip 102b and the other 60 holes are located around the pen tip. In particular, the other holes include six groups of holes 102b-h4, 102b-h5, 102b-h6, 102b-h7, 102b-h8, and 102b-h9. Each of these six groups of holes includes a total of 11 holes, which extend in linear fashion from one side of the pen tip 102b to the other side of the pen tip and pass through the central hole 102b-h3. As such, central hole 102b-h3 is common to each of the six groups of holes. In one embodiment, the lines of holes are disposed around the pen tip 102b at approximately 30 degree intervals. Considering, for example, the group of holes 102b-h4, there are 5 holes 102b-h4 on the left side of the central hole 102b-h3 and 5 holes 102b-h4 on the right side of the central hole. Thus, including the central hole 102b-h3, the line of holes 102b-h4 includes a total of 11 holes. When the pen tip is configured for a relatively high number of flexible fibers, e.g., 50 to 100 flexible fibers, the flexible fibers should be extremely thin. In one embodiment, the flexible fibers have a diameter of in a range from approximately 0.04 millimeter to approximately 0.06 millimeter. Each of the holes 102b-h3, 102b-h4, 102b-h5, 102b-h6, 102b-h7, 102b-h8, and 102b-h9 should have a size sufficiently large to accommodate the combined size, e.g., diameter, of the flexible fiber and any sleeve surrounding the flexible fiber.

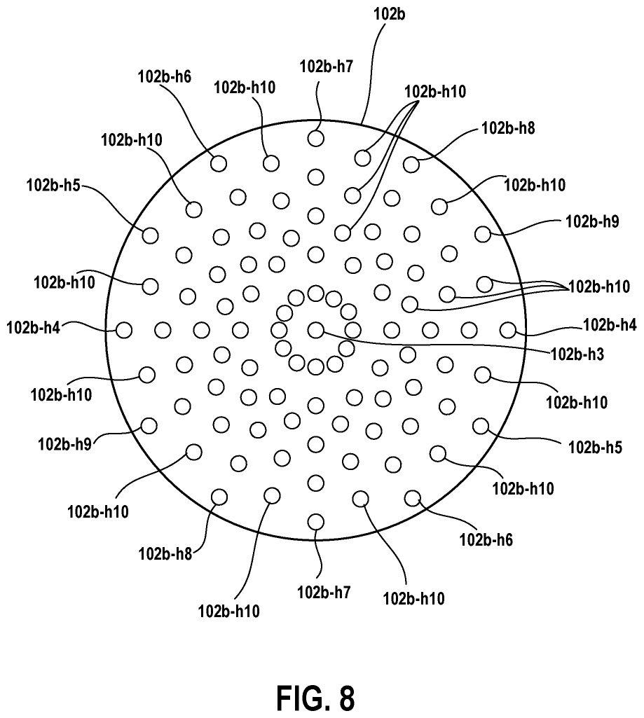

FIG. 8 is a front view of the pen tip that shows the location of the holes formed in the pen tip for the flexible fibers, in accordance with a further embodiment. As shown in FIG. 8, the pen tip 102b has 97 holes formed therein. As can be seen in FIG. 8, one of the holes 102b-h3 is centrally located on the pen tip 102b and the other 96 holes are located around the pen tip. In particular, the other holes include the six groups of holes 102b-h4, 102b-h5, 102b-h6, 102b-h7, 102b-h8, and 102b-h9 described above with reference to FIG. 7 (these six groups include a total of 60 holes). In addition, the other holes include twelve groups of holes 102b-h10, with each of these groups including 3 holes (thus these twelve groups include a total of 36 holes). Each of the twelve groups of holes 102b-h10 is located between two of the six groups of holes 102b-h4, 102b-h5, 102b-h6, 102b-h7, 102b-h8, and 102b-h9. For example, three holes 102b-h10 on the left side of the pen tip 102b are located between the groups of holes 102b-h4 and 102b-h5, and three holes 102b-h10 on the right side of the pen tip are located between the groups of holes 102b-h4 and 102b-h9. As the pen tip 102b in the example embodiment of FIG. 8 is configured for a relatively high number of flexible fibers, e.g., 50 to 100 flexible fibers, the flexible fibers should be extremely thin, e.g., approximately 0.04 millimeter to approximately 0.06 millimeter. Each of the holes 102b-h3, 102b-h4, 102b-h5, 102b-h6, 102b-h7, 102b-h8, 102b-h9, and 102b-h10 should have a size sufficiently large to accommodate the combined size, e.g., diameter, of the flexible fiber and any sleeve surrounding the flexible fiber.

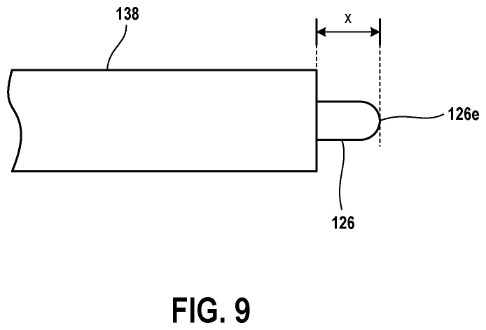

As the number of flexible fibers, e.g., fiber optic strands, protruding from the pen tip increases, the likelihood of interference from light traveling through neighboring fiber optic strands increases. To reduce the likelihood of such interference, the distance by which each fiber optic strand extends beyond the end of the sleeve surrounding the fiber optic strand should be reduced as the density of fiber optic strands on the pen tip increases. FIG. 9 shows a sleeve surrounding a fiber optic strand such that an end portion of the fiber optic strand extends beyond the end of the sleeve, in accordance with one embodiment. As shown in FIG. 9, sleeve 138 surrounds fiber optic strand 126 and an end portion of the fiber optic strand extends beyond the end of the sleeve. The distance X, which extends from the end of the sleeve 138 to fiber end 126e of fiber optic strand 126, defines the distance by which the fiber optic strand extends beyond the end of the sleeve. In one example embodiment, the distance X is in a range from approximately 0.25 millimeter to approximately 5 millimeters. In another example embodiment, the distance X is in a range from approximately 0.5 millimeter to approximately 2 millimeters. In yet another example embodiment, the distance X is approximately 1 millimeter. Reducing the distance by which the fiber optic strand extends beyond the end of the sleeve (the distance X) as the density of the fiber optic strands on the pen tip increases helps ensure that the substantial majority of light detected by the sensor associated with each fiber optic strand is light reflected from the surface of the display panel, rather than light from neighboring fiber optic strands. In the example embodiments in which the distance X is relatively short, e.g., in the range from 0.25 millimeter to 2 millimeters, the degree to which the exposed portion of the fiber optic strand can flex or bend when pressed against the surface of the display panel might be limited, but the flexibility of the sleeve will allow the fiber optic strand as a whole to flex or bend so that the amount of light reflected from the surface of the display panel will be indicative of the amount of pressure being applied to the surface of the display panel by the fiber optic strand.

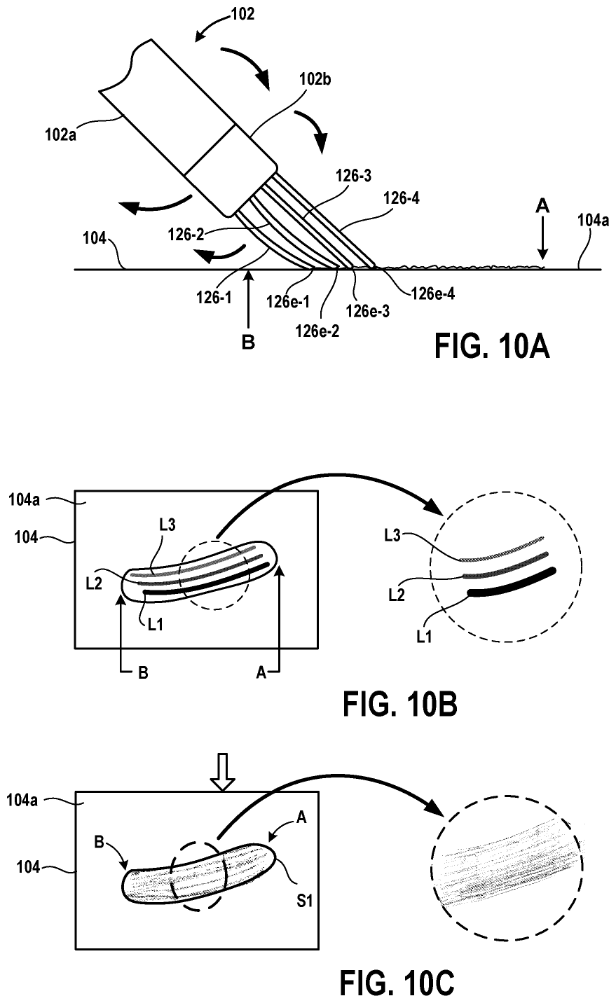

FIG. 10A illustrates a digital pen having multiple inputs being moved on the surface of a display panel, in accordance with one embodiment. As shown in FIG. 10A, digital pen 102 is being moved on the surface 104a of display 104 along a drawing trajectory from point A to point B. In this example embodiment, digital pen 102 includes four flexible fibers, e.g., fiber optic strands, 126-1, 126-2, 126-3, and 126-4, which protrude from pen tip 102b (for ease of illustration, the flexible fibers 126-1, 126-2, 126-3, and 126-4 are shown without the sleeves that would be present in normal use). As can be seen in FIG. 10A, as the digital pen 102 is being moved from point A to point B, the fiber ends 126e-1, 126e-2, and 126e-3 are being pressed into contact with the surface 104a of the display panel 104, whereas fiber end 126e-4 is not in contact with the surface of the display panel. The arrows in FIG. 10A indicate that digital pen 102 is simultaneously being pressed against the surface 104a of the display panel 104 as well as being moved on the surface of the display panel from point A to point B. The intensity of the line draw for each of the flexible fibers depends on the amount of flex contact for each of the fiber ends of the flexible fibers, as will be explained in more detail below with reference to FIG. 10B.

FIG. 10B illustrates the line draw for each the flexible fibers shown in FIG. 10A, in accordance with one embodiment. As shown in FIG. 10B, there are three line draws L1, L2, and L3 on the surface 104a of display panel 104, and these line draws extend substantially from point A to point B. Line draw L1 is the result of the contact of fiber end 126e-1 with the surface 104a of the display panel 104. Line draw L2 is the result of the contact of fiber end 126e-2 with the surface 104a of the display panel 104. Line draw L3 is the result of the contact of fiber end 126e-3 with the surface 104a of the display panel 104. There is no line draw corresponding to fiber end 126e-4 in FIG. 10B because, as shown in FIG. 10A, fiber end 126e-4 was not in contact with the surface 104a of the display panel 104 as the digital pen 102 was being moved from point A to point B. The line draws L1, L2, and L3 shown in FIG. 10B are the “raw” line draws resulting from the movement of the digital pen 102 on the surface 104a of the display panel 104 before the line draws have been interpolated, e.g., by content creation software, to generate a simulated brush stroke, which produces a graphical brush stroke on an interface rendered on the display panel. Additional detail regarding the interpolation of the line draws are described below with reference to FIG. 10C.

As can be seen in the enlarged portion of FIG. 10B (the portion inside the dashed circle), the intensity, e.g., the thickness and boldness, of the line draw L1 is greater than the intensity of either line draws L2 or L3. The reason for this is that the pressure being applied to fiber optic strand 126-1 as the digital pen 102 is being moved from point A to point B is higher than the pressure being applied to either fiber optic strands 126-2 or 126-3. Consequently, as can be seen in FIG. 10A, the amount of flex contact that fiber optic strand 126-1 has with the surface 104a of display panel 104 is greater than the amount of flex contact that either fiber optic strands 126-2 or 126-3 have with the surface of the display panel because the increased pressure has caused the fiber optic strand 126-1 to flex or bend more than either fiber optic strands 126-2 or 126-3 have flexed or bent. As the result of the increased flex contact fiber optic strand 126-1 has with the surface 104a of the display 104, the fiber end 126e-1 of fiber optic strand 126-1 will reflect relatively more light back to the associated sensor in the optical sensor array and thus cause this sensor to detect a more robust signal.

As also can be seen in the enlarged portion of FIG. 10B, the intensity, e.g., the thickness and boldness, of the line draw L2 is greater than the intensity of the line draw L3. The reason for this is that the pressure being applied to fiber optic strand 126-2 as the digital pen 102 is being moved from point A to point B is higher than the pressure being applied to fiber optic strand 126-3. Consequently, as can be seen in FIG. 10A, the amount of flex contact that fiber optic strand 126-2 has with the surface 104a of display panel 104 is slightly greater than the amount of flex contact that fiber optic strand 126-3 has with the surface of the display panel because the increased pressure has caused the fiber optic strand 126-2 to flex or bend slightly more than fiber optic strand 126-3 has flexed or bent. As the result of the increased flex contact fiber optic strand 126-2 has with the surface 104a of the display 104, the fiber end 126e-2 of fiber optic strand 126-2 will reflect relatively more light back to the associated sensor in the optical sensor array and thus cause this sensor to detect a more robust signal.

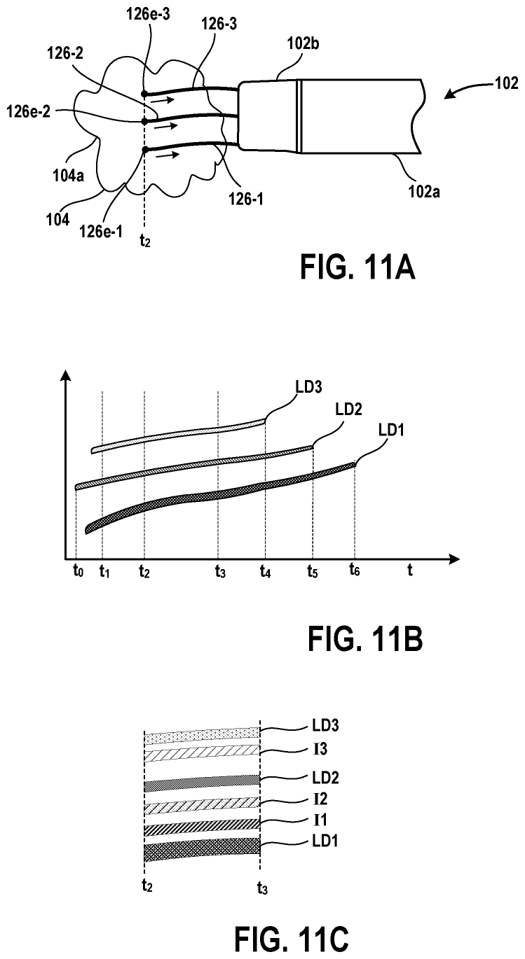

FIG. 10C illustrates a graphical brush stroke on an interface rendered on a display panel, in accordance with one embodiment. As shown in FIG. 10C, graphical brush stroke S1 appears on an interface rendered on the display panel 104. The graphical brush stroke S1 is generated by conducting an interpolation process on the line draws L1, L2, and L3 (see FIG. 10B) to generate a simulated brush stroke. The simulated brush stroke is then used to produce the graphical brush stroke S1 on the interface rendered on the display panel 104. In one embodiment, the interpolation process is carried out by content creation software and includes the use of a randomizing function. By way of example, in the randomizing function, random numbers are generated and these random numbers are used to select the locations at which interpolated data is added to the original line draws (see, e.g., FIGS. 11A-11C for additional details regarding the interpolation process).

As can be seen in the enlarged portion of FIG. 10C (the portion inside the dashed circle), the lower portion of graphical brush stroke S1 is relatively dark, the upper portion of the graphical brush stroke is relatively light, and the center portion of the graphical brush stroke transitions from relatively dark to relatively light (moving in the direction from the bottom of the graphical brush stroke toward the top of the graphical brush stroke). The content creation software generates the graphical brush stroke S1 using, among other things, 1) the line draws L1, L2, and L3 (see FIG. 10B), and 2) the interpolation process that adds data to the original line draws at randomly selected locations. The lower portion of the graphical brush stroke S1 is relatively dark because this portion corresponds to the location of line draw L1, which had the most intensity, e.g., thickness and boldness, of the line draws L1, L2, and L3 due to the relatively high pressure applied to fiber optic strand 126-1. The upper portion of the graphical brush stroke S1 is relatively light because this portion corresponds to the location of line draw L3, which had the least intensity of the line draws L1, L2, and L3 due to the relatively low pressure applied to fiber optic strand 126-3. Through the use of the multiple data points provided by, e.g., line draws L1, L2, and L3, as well the interpolation process including the randomizing function, the graphical brush stroke S1 generated by the content creation software more closely replicates a brush stroke made by a real paint brush. In particular, one reason for this is that the use of a digital pen with multiple inputs, e.g., multiple fiber optic strands, allows a digital artist to introduce human variance into the digital painting process, e.g., through the application of different amounts of pressure to one or more of the multiple inputs, and thereby capture more of the true ability of the digital artist.

FIGS. 11A-11C illustrate additional details of the interpolation process used to convert the line draws into a simulated brush stroke, in accordance with one embodiment. FIG. 11A shows a simplified illustration of a digital pen 102 being moved (from left to right) on the surface 104a of display panel 104. As shown in FIG. 11A, digital pen 102 includes three flexible fibers, e.g., fiber optic strands, 126-1, 126-2, and 126-3, which protrude from pen tip 102b (for ease of illustration, the flexible fibers 126-1, 126-2, and 126-3 are shown without the sleeves that would be present in normal use). As the digital pen 102 is being moved along a drawing trajectory, the fiber ends 126e-1, 126e-2, and 126e-3 are being pressed into contact with the surface 104a of the display panel 104.

FIG. 11B is a graph that shows the resulting line draws for each of the fiber optic strands as a function of time. As shown in FIG. 11B, line draw LD1 is the result of the contact of fiber end 126e-1 with the surface 104a of the display panel 104 along the drawing trajectory. Line draw LD2 is the result of the contact of fiber end 126e-2 with the surface 104a of the display panel 104 along the drawing trajectory. Line draw LD3 is the result of the contact of fiber end 126e-3 with the surface 104a of the display panel 104 along the drawing trajectory. As can be seen in the graph of FIG. 11B, line draw LD1 extends from just before time t₁ to time t₆. Line draw LD2 extends from time t₀ to time t₅, which means that the fiber end 126e-2 was not in contact with the surface 104a of the display panel 104 after time t₅. Line draw LD3 extends from just before time t₁ to time t₄, which means that fiber end 126e-3 was not in contact with the surface 104a of the display panel 104 after time t₄.

FIG. 11C illustrates the addition of interpolated data to the line draws LD1, LD2, and LD3 during the period of time from t₂ to t₃ shown in FIG. 11B. As shown in FIG. 11C, interpolated data lines 12 and 13 have been inserted between line draws LD1 and LD2. The content creation software determines the intensity, e.g., the thickness and the boldness, of the interpolated data lines 12 and 13 to be added between line draws LD1 and LD2. The intensity determination for the interpolated data lines is influenced by the intensity of the surrounding line draws LD1 and LD2. Thus, by way of example, the interpolated data lines will be thicker and bolder when the line draws LD1 and LD2 are thicker and bolder. In one embodiment, the positions at which the interpolated data lines 12 and 13 are added between line draws LD1 and LD2 are determined using a randomizing function. In one example embodiment, a random seed is used to initialize a pseudorandom number generator and generate a sequence of random numbers. In this example embodiment, the content creation software uses the random numbers to determine random positions at which the interpolated data lines 12 and 13 are added between the line draws LD1 and LD2. By randomly inserting the interpolated data between the line draws rather than, e.g., inserting the interpolated data at predefined locations between the line draws, the resulting simulated brush stroke has an appearance that more closely replicates a brush stroke made by a real paint brush.

As shown in FIG. 11C, interpolated data line 13 has been added between line draws LD2 and LD3. As noted above, the intensity, e.g., the thickness and boldness, of the interpolated data line 13, which is determined by the content creation software, is influenced by the intensity of the surrounding line draws LD2 and LD3. Further, in one example embodiment, the location of interpolated data line 13 is randomly determined by the content creation software using a randomizing function. As can be seen in FIG. 11C, the random position at which interpolated data line 13 is located is closer to line draw LD3 than to line draw LD2. As noted above, with the use of the randomizing function, the resulting simulated brush stroke has an appearance that more closely replicates a brush stroke made by a real paint brush. Without the randomizing function, an interpolated data line would typically be automatically located at the midway point between line draws, e.g., halfway between line draw LD2 and line draw LD3, and therefore would have a less realistic appearance. In the example embodiments shown in FIG. 11C, one or two interpolated data lines have been added between the line draws resulting from the use of the digital pen with multiple inputs. Those skilled in the art will appreciate that any number of interpolated data lines, e.g., 3, 5, 10, 50, etc., can be added in between the original line draws. Those skilled in the art also will appreciate that the randomizing function can be implemented during more than one time period during which the line draws are being generated. By way of example, the randomizing function could be implemented for each time period, e.g., from t₂ to t₃, from t₃ to t₄, from t₄ to t₅, etc., for every other time period, e.g., from t₁ to t₂, from t₃ to t₄, from t₅ to t₆, etc, or for multiple time periods, e.g., from t₀ to t₂, from t₂ to t₄, from t₄ to t₆, etc.

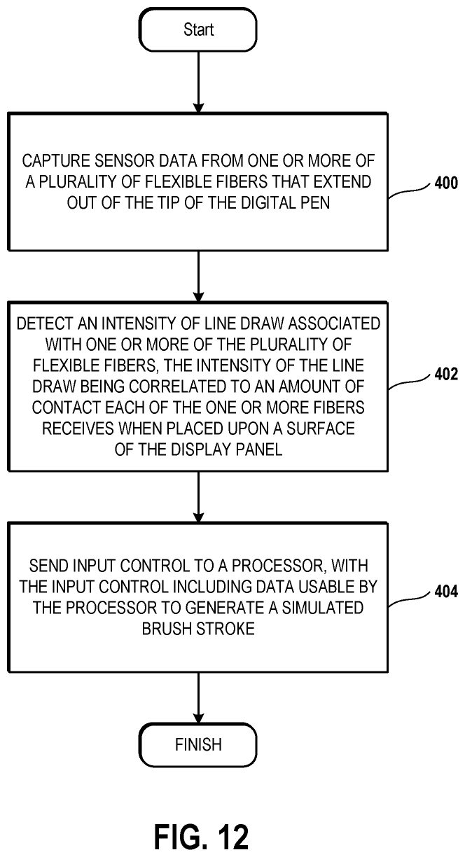

FIG. 12 is a flow diagram illustrating the method operations performed in generating input control from a digital pen used for drawing on a display panel, in accordance with an example embodiment. The method begins in operation 400 in which sensor data is captured from one or more of a plurality of flexible fibers that extend of the tip of the digital pen. In one embodiment, the flexible fibers are fiber optic strands through which light is transmitted. It will be appreciated by those skilled in the art, however, that the method can be implemented using other types of flexible fibers, e.g., thin metallic wires, spring tips, etc. In the example in which the flexible fibers are fiber optic strands, the sensor data can be captured by emitting light to the fiber optic strands, and receiving the reflected light from one or more of the fiber ends of the fiber optic strands contacting the surface of the display panel. The reflected light can be captured by any suitable sensor, e.g., sensor 136 which forms part of optical sensor array 118 (see, e.g., FIG. 3).

In operation 402, the intensity of line draw associated with one or more of the plurality of flexible fibers is detected, with the intensity of the line draw being correlated to an amount of contact each of the one or more of the plurality of flexible fibers receives when placed upon the surface of the display panel. The sensor data captured in operation 400 is raw signal data. In the detecting performed as part of operation 402, a basic analysis of this raw signal data is performed, e.g., by a processor, to generate relative magnitudes of intensity of the captured sensor data. As such, the detecting performed as part of operation 402 will identify the flexible fibers that have had the most flex contact with the surface of the display panel (and therefore generated more reflected light relative to the other flexible fibers) while the digital pen was being moved on the surface of the display panel.

In operation 404, input control is sent to a processor, with the input control including data usable by the processor to generate a simulated brush stroke. The simulated brush stroke is configured to be rendered on the display panel responsive to the amount of contact each of the one or more of the plurality of flexible fibers receives when placed upon the surface of the display panel. The input control can be sent to the processor using any suitable wireless protocol. In one embodiment, the input control is sent to a paired device using the Bluetooth Low Energy (BLE) protocol. In one embodiment, the paired device is a tablet computer and the processor is located on the display panel of the tablet computer. In another embodiment, the paired device is a computer and the processor is located on the computer, which is connected to a display panel. In the example embodiment using the BLE protocol, the input control is a packet stream being sent to the processor, with the packet stream including, among other data items, the intensity data generated in operation 402. The processor uses the input control, in conjunction with content creation software, e.g., an application program, that resides on the processor create simulated brush strokes that include characteristics based, at least in part, on the intensity data included in the input control.

In one embodiment, the generating of the simulated brush stroke by the processor includes processing an interpolation process. The interpolation process is configured to digitally produce a plurality of interpolated line draws with respective line weights based on the intensity of the line draw associated with each of the one or more of the plurality of flexible fibers. As described above with reference to FIGS. 11A-11C, interpolated data lines are added between the original line draws resulting from use of the digital pen with multiple inputs, e.g., flexible fibers. In addition, interpolated data lines can be added outside of an original line draw, e.g., when the original line draw is the outermost line draw resulting from use of the digital pen with multiple inputs. In one embodiment, the location of the interpolated data lines is determined using a randomizing function. The content creation software determines the intensity, e.g., the thickness and the boldness, of the interpolated data lines to be added between the original line draws (or outside of one of the outermost original line draws). The intensity determination for the interpolated data lines is influenced by the intensity, e.g., the thickness and boldness, of the surrounding line draws (or the most proximate line draw). Thus, by way of example, the interpolated data lines will have greater line weights when the intensity of the surrounding line draws is higher. As used herein, the phrase “line weight” refers to a thickness of a data line in terms of the number of pixels used to render a graphical version of the data line on a display panel. Those skilled in the art will appreciate that the pixel density will vary based on resolution of the tablet display panel. As such, more pixels will be used to render the graphical version of the data line at higher resolutions than will be used to render the graphical version of the data line at lower resolutions.

In one embodiment in which each of the plurality of flexible fibers is defined by a fiber optic strand, the capturing of sensor data from the plurality of flexible fibers that extend out the tip of the digital pen includes individually emitting light to each fiber optic strand, and receiving reflected light from the ends of one or more of the fiber optic strands, with the ends of the one or more fiber optic strands contacting the surface of the display panel. Light can be individually emitted to each fiber optic strand using any suitable light emitter, e.g., a light emitting diode (LED). By way of example, the optical sensor array 118 shown in, e.g., FIG. 3, includes a light emitter 134 for each fiber optic strand 126. The reflected light from the ends of one or more fiber optic strands can be received using any suitable sensor. By way of example, the optical sensor array 118 shown in, e.g., FIG. 3, includes a sensor 136 for each fiber optic strand 126. As described above, when the fiber end of one of the fiber optic strands is in contact with a reflective surface, e.g., the surface of the display panel, the light reflected from the reflective surface will travel back along the fiber optic strand and get detected as reflected light by the sensor associated with the fiber optic strand.

In traditional painting, an artist uses a variety of brushes to achieve different effects. By way of non-limiting example, these brushes include round brushes, flat brushes, and fan brushes. It will be apparent to those skilled in the art that the flexible fibers, e.g., fiber optic strands, described herein can be arranged to define a shape that is comparable to that of a round brush, a flat brush, or a fan brush used in traditional painting. Those skilled in the art will also appreciate that other techniques can be used to adjust the shape of the flexible fibers protruding from the pen tip of the digital pen. For example, a conformable clamp can be placed around the flexible fibers. By changing the shape of the conformable clamp, e.g., by squeezing the clamp together, the shape of the flexible fibers can be adjusted to a desired shape. Alternatively, the digital pen can be provided with one or more dials that can be used to adjust the length by which each of the flexible fibers extends beyond the outer surface of the pen tip. For example, the digital pen can be provided with a first dial to adjust the overall length of the flexible fibers and a second dial to adjust the radial falloff of the flexible fibers (the degree to which the outer flexible fibers are shorter than the inner flexible fibers).

In the example embodiments described herein, the flexible fibers are fiber optic strands which transmit light that gets reflected from the surface of a display panel. It will be apparent to those skilled in the art that the principles described herein can be implemented using flexible fibers other than fiber optic strands. By way of example, the flexible fibers can be spring tips or thin metallic wires.

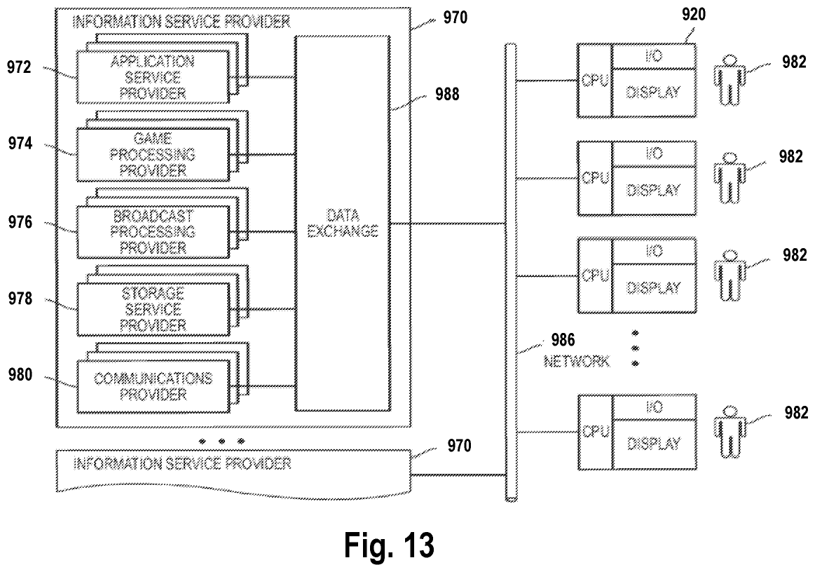

As described above, the digital pen transmits input control to a paired device with which a processor is associated. In one example in which the paired device is a tablet computer, the processor can be located on the display panel of the tablet computer. In another example in which the paired device is a computer, the processor can be located on the computer, which is connected to the display panel. In either of these examples, the processing of the data from the digital pen can be carried out in the cloud. To enable such cloud processing of the data, the paired device, e.g., the tablet computer or the computer connected to the display panel, can be connected to the cloud via any suitable internet connection. FIG. 13 illustrates an embodiment of an Information Service Provider architecture. Information Service Provider (ISP) 970 delivers a multitude of information services to users 982 geographically dispersed and connected via network 986. An ISP can deliver just one type of service, such as stock price updates, or a variety of services such as broadcast media, news, sports, gaming, etc. Additionally, the services offered by each ISP are dynamic, that is, services can be added or taken away at any point in time. Thus, the ISP providing a particular type of service to a particular individual can change over time. For example, a user may be served by an ISP in near proximity to the user while the user is in her home town, and the user may be served by a different ISP when the user travels to a different city. The home-town ISP will transfer the required information and data to the new ISP, such that the user information “follows” the user to the new city making the data closer to the user and easier to access. In another embodiment, a master-server relationship may be established between a master ISP, which manages the information for the user, and a server ISP that interfaces directly with the user under control from the master ISP. In another embodiment, the data is transferred from one ISP to another ISP as the client moves around the world to make the ISP in better position to service the user be the one that delivers these services.

ISP 970 includes Application Service Provider (ASP) 972, which provides computer-based services to customers over a network (e.g., including by way of example without limitation, any wired or wireless network, LAN, WAN, WiFi, broadband, cable, fiber optic, satellite, cellular (e.g. 4G, 5G, etc.), the Internet, etc.). Software offered using an ASP model is also sometimes called on-demand software or software as a service (SaaS). A simple form of providing access to a particular application program (such as customer relationship management) is by using a standard protocol such as HTTP. The application software resides on the vendor's system and is accessed by users through a web browser using HTML, by special purpose client software provided by the vendor, or other remote interface such as a thin client.

Services delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common business applications online that are accessed from a web browser, while the software and data are stored on the servers. The term cloud is used as a metaphor for the internet (e.g., using servers, storage and logic), based on how the internet is depicted in computer network diagrams and is an abstraction for the complex infrastructure it conceals.

Further, ISP 970 includes a Game Processing Server (GPS) 974 which is used by game clients to play single and multiplayer video games. Most video games played over the internet operate via a connection to a game server. Typically, games use a dedicated server application that collects data from players and distributes it to other players. This requires a separate server to host the server application. In another embodiment, the GPS establishes communication between the players and their respective game-playing devices exchange information without relying on the centralized GPS. In yet another embodiment, the GPS can be used to distribute game copies to nodes via download and to facilitate a discovery process by which nodes can initiate a peer-to-peer connection with other nodes interested in playing a game in a serverless environment.

Dedicated GPSs are servers which run independently of the client. Such servers are usually run on dedicated hardware located in data centers, providing more bandwidth and dedicated processing power. Dedicated servers are the preferred method of hosting game servers for most PC-based multiplayer games. Massively multiplayer online games run on dedicated servers usually hosted by the software company that owns the game title, allowing them to control and update content.

Broadcast Processing Server (BPS) 976 distributes audio or video signals to an audience. Broadcasting to a very narrow range of audience is sometimes called narrowcasting. The final leg of broadcast distribution is how the signal gets to the listener or viewer, and it may come over the air as with a radio station or TV station to an antenna and receiver, or may come through cable TV or cable radio (or “wireless cable”) via the station or directly from a network. The internet may also bring either radio or TV to the recipient, especially with multicasting allowing the signal and bandwidth to be shared. Historically, broadcasts have been delimited by a geographic region, such as national broadcasts or regional broadcast. However, with the proliferation of fast internet, broadcasts are not defined by geographies as the content can reach almost any country in the world.

Storage Service Provider (SSP) 978 provides computer storage space and related management services. SSPs also offer periodic backup and archiving. By offering storage as a service, users can order more storage as required. Another major advantage is that SSPs include backup services and users will not lose all their data if their computers' hard drives fail. Further, a plurality of SSPs can have total or partial copies of the user data, allowing users to access data in an efficient way independently of where the user is located or the device being used to access the data. For example, a user can access personal files in the home computer, as well as in a mobile phone while the user is on the move.

Communications Provider 980 provides connectivity to the users. One kind of Communications Provider is an Internet Service Provider (ISP) which offers access to the Internet. The ISP connects its customers using a data transmission technology appropriate for delivering Internet Protocol datagrams, such as dial-up, DSL, cable modem, fiber, wireless or dedicated high-speed interconnects. The Communications Provider can also provide messaging services, such as e-mail, instant messaging, and SMS texting. Another type of Communications Provider is the Network Service Provider (NSP) which sells bandwidth or network access by providing direct backbone access to the Internet. Network service providers include telecommunications companies, data carriers, wireless communications providers, Internet service providers, cable television operators offering high-speed internet access, etc.

Data Exchange 988 interconnects the several modules inside ISP 970 and connects these modules to users 982 via network 986. Data Exchange 988 can cover a small area where all the modules of ISP 970 are in close proximity, or can cover a large geographic area when the different modules are geographically dispersed. For example, Data Exchange 988 can include a fast Gigabit Ethernet (or faster) within a cabinet of a data center, or an intercontinental virtual area network (VLAN).

Users 982 access the remote services with client device 920, which includes at least a CPU, a memory, a display and I/O. The client device can be a PC, a mobile phone, a netbook, tablet, gaming system, a PDA, etc. In one embodiment, ISP 970 recognizes the type of device used by the client and adjusts the communication method employed. In other cases, client devices use a standard communications method, such as HTML, to access ISP 970.

Embodiments of the present disclosure may be practiced with various computer system configurations including hand-held devices, microprocessor systems, microprocessor-based or programmable consumer electronics, minicomputers, mainframe computers and the like. The disclosure can also be practiced in distributed computing environments where tasks are performed by remote processing devices that are linked through a wire-based or wireless network.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The disclosure can also be embodied as computer readable code on a computer readable medium. Alternately, the computer readable code may be downloaded from a server using the data exchange interconnects described above. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although method operations may be described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Accordingly, the disclosure of the example embodiments is intended to be illustrative, but not limiting, of the scope of the disclosures, which are set forth in the following claims and their equivalents. Although example embodiments of the disclosures have been described in some detail for purposes of clarity of understanding, it will be apparent that certain changes and modifications can be practiced within the scope of the following claims. In the following claims, elements and/or steps do not imply any particular order of operation, unless explicitly stated in the claims or implicitly required by the disclosure.

What is claimed is:

1. A digital pen for use in drawing via a display panel, comprising:
a body of the pen having a first end and a second end, the body including processing circuitry for processing input data and communicating input control to a processor associated with the display panel; and
a tip having a connector for coupling to the first end of the body of the pen and a contact interface opposite the connector, the tip including capture circuitry that processes sensor data from the contact interface and produces the input data that is interfaced to the processing circuitry of the body, the contact interface is defined by a plurality of flexible fibers, each of the plurality of flexible fibers having a fiber end that is configured to contact a surface of the display panel for producing the sensor data, the sensor data identifying an amount of flex contact of each of the plurality of flexible fibers, the amount of flex contact is correlated to an intensity of line draw for each of the fiber ends of the plurality of flexible fibers,
wherein input control includes instructions usable by the processor associated with the display panel to produce a simulated brush stroke on the display panel,
wherein the tip includes a microcontroller that identifies the amount of flex contact from the sensor data, and the intensity of line draw for each of the fiber ends is used to set values for producing a plurality of interpolated line draws with respective line weights when the processor associated with the display panel produces the simulated brush stroke, and
wherein each interpolated line draw is added to a location identified by a randomizing function when generating the simulated brush stroke.

2. The digital pen of claim 1, wherein each of the plurality of flexible fibers is defined by a fiber optic strand and an end opposite the fiber end of each fiber optic strand connects to an optical sensor array.

3. The digital pen of claim 2, wherein the optical sensor array is configured to individually emit light to each fiber optic strand and receive reflected light from each of the respective fiber ends, the received reflected light represents the sensor data from the contact interface.

4. The digital pen of claim 3, wherein the microcontroller receives the sensor data and produces the input data that is communicated to the connector via a pen tip interface.

5. (canceled)

6. The digital pen of claim 1, wherein the simulated brush stroke produces a graphical brush stroke on an interface rendered on the display panel.

7. The digital pen of claim 1, wherein the simulated brush stroke produces a graphical brush stroke on an interface rendered on the display panel, and the capture circuitry and the processing circuitry of the digital pen are configured to produce the input control for a period of time when at least one of the fiber ends produces sensor data indicative of a continuing of the simulated brush stoke along a drawing trajectory across a portion of the display panel.

8. The digital pen of claim 7, wherein the simulated brush stroke is in part generated by digitally producing a plurality of interpolated line draws with respective line weights based on the intensity of the line draw determined for each of the plurality of flexible fibers, and the intensity of the line draw changes, responsive to an amount of the contact of the plurality of flexible fibers with the surface of the display panel, wherein the changes in the intensity of the line draw affect an intensity of the simulated brush stroke while moving the plurality of flexible fibers along the drawing trajectory.

9. The digital pen of claim 1, wherein each of the plurality of flexible fibers includes a shielding cover that extends toward the fiber ends, the fiber ends being free of the shielding cover to enable the fiber ends to contact the surface of the display panel.

10. The digital pen of claim 9, further comprising:
a magnetic cover that surrounds the shielding cover, the magnetic cover is configured to assist in keeping the plurality of flexible fibers substantially together.

11. The digital pen of claim 1, wherein the processing circuitry includes a communication chip, a microcontroller, a pen body interface, and a power source.

12. The digital pen of claim 1, wherein the capture circuitry includes an optical sensor array, a microcontroller with cache, and a pen tip interface.

13. The digital pen of claim 1, wherein the plurality of flexible fibers includes at least three flexible fibers and at least three corresponding fiber ends.

14. A method for generating input control from a digital pen used for drawing on a display panel, the digital pen having a pen body and a tip, comprising:
capturing sensor data from one or more of a plurality of flexible fibers that extend out of the tip;
detecting an intensity of line draw associated with one or more of the plurality of flexible fibers, the intensity of the line draw being correlated to an amount of contact each of the one or more of the plurality of flexible fibers receives when placed upon a surface of the display panel; and
sending input control to a processor, the input control includes data usable by the processor to generate a simulated brush stroke, the simulated brush stroke is configured to be rendered on the display panel responsive to the amount of contact each of the one or more of the plurality of flexible fibers receives when placed upon the surface of the display panel, and the generating of the simulated brush stroke by the processor includes processing an interpolation process, the interpolation process is configured to digitally produce a plurality of interpolated line draws with respective line weights based on the intensity of the line draw associated with each of the one of more of the plurality of flexible fibers,
wherein each interpolated line draw is added to a location identified by a randomizing function when generating the simulated brush stroke.

15. (canceled)

16. The method of claim 14, wherein each of the plurality of flexible fibers is defined by a fiber optic strand, and capturing sensor data from the plurality of flexible fibers that extend out of the tip includes:
individually emitting light to each fiber optic strand; and
receiving reflected light from ends of one or more of the fiber optic strands, the ends of the one or more of the fiber optic strands contacting a surface of the display panel.

17. The method of claim 14, wherein capturing sensor data from the plurality of flexible fibers that extend out of the tip includes capturing sensor data from at least three flexible fibers.

18. The method of claim 14, wherein the plurality of flexible fibers that extend out of the tip is arranged in a pattern that simulates a round brush.

19. The method of claim 14, wherein the plurality of flexible fibers that extend out of the tip is arranged in a pattern that simulates a flat brush.

20. The method of claim 14, wherein the plurality of flexible fibers that extend out of the tip is arranged in a pattern that simulates a fan brush.
